(19) United States
(12) Patent Application Publication
(10) Pub. No.: US 2005/0287502 A1
(43) Pub. Date: Dec. 29, 2005

(54) Health maintenance system for children

(76) Inventors: Barbara Helen Southard, Floyd, VA (US); Douglas Ralph Southard, Floyd, VA (US)

Correspondence Address: THE TECHNOLOGY LAW OFFICES OF VIRGINIA;Virginia Tech Corporate Research Center, Suite 1100, 1872 Pratt Drive, Blacksburgh, VA, 24060-6363, US

(21) Appl. No.: 10/878,202

(22) Filed: Jun. 28, 2004

(51) Int. Cl. G09B 19/00

(52) U.S. Cl. 434/236

(57) ABSTRACT

A system for monitoring and maintaining dietary intake and physical activity levels for children which involves reinforcing good dietary practices and punishing poor activity and dietary practices which utilizes a core application controlling access to selected third party software and which has an interface to allow parents to set goals and plan contingencies.

This system is for monitoring children's dietary intake and physical activity levels by reinforcing good dietary and activity practices while punishing sedentary activity and poor dietary practices. Specifically, the system utilizes a core application that controls access to selected third party software and which has design interfaces that guide parents and/or guardians in setting goals and contingencies and for data input. The interfaces are coded so as to plug into the core application. Each child's parents have a resource website available to them and an interface that allows them to evaluate the success of their child's efforts.

### BACKGROUND

Over fifteen percent of American children were overweight in the year 2000, more than triple that of a generation before, with rates even higher for some minorities. This epidemic puts the nation's youth at risk for diabetes, hypertension and low self-esteem. This has been reported in National Institutes of Health reports in 2002, Figueroa-Colon, et al 1997; Moran 1999. Additionally, as childhood is a powerful predictor of adult obesity, overweight children are at a higher risk in the future for cardiovascular and other chronic diseases.

Most experts in the field of children's nutrition agree that in order to prevent increases in morbidity and mortality and in health care costs, an effort must be made now to detect and treat childhood obesity. This can be done by motivating families to increase physical activity, decrease sedentary behaviors, and improve eating patterns. See studies by Moran, 1999, Ariza et al 2004, Zametin 2004.

Zametkin and his colleagues also emphasize the importance of specifying behavoiral goals and involving parents in the treatment of this disorder. In an effort to heed these recommendations and confront this health issue, the inventors have developed this system which is a computer application that enables parents to facilitate improvements in their children's dietary intake and physical activity levels by using computer games as a reward for desired behaviors. The program acts as a gatekeeper by denying or limiting access to selected games locally or online until the child has achieved or made progress towards behavorial goals set by the parents. When the word “parents” is used herein, it is understood that it is meant to include legal guardians, as well. The technology is used by parents to provide incentives for children to eat fruits and vegetables, become more active, reduce the amount of TV and computer or video game watching or playing, as well as for encouraging or discouraging specific behaviors related to eating patterns, sedentary behavior, or physical activity.

Consistent with the goals of increasing quality and years of healthy life, the system provides parents with a valuable tool to help their children manage their weight and, as a result, reduce their overall risk of death while increasing the quality of their lives. In addition, since childhood obesity increases the risk of heart disease and because nutrition and physical activity are key to weight management, this system addresses the problem before it becomes a problem.

According to the Centers for Disease Control, 15.5% of children 12 to 19 years of age were overweight. Rates for younger children were not much better, with 15.3% of children aged 6 to 11 classified as overweight, more than triple the rates just a generation before. Rates for African American girls and Mexican boys were 25% and 27%, respectively, for the year 2000. These escalating rates of obesity threaten to impact on the nation's overall morbidity and have prompted overall concern about the nation's health.

There is mounting evidence that childhood obesity brings with it serious short and long term health risks. Studies suggest that obese children and adolescents tend to have impaired glucose tolerance, which puts them at risk for developing Type 2 diabetes. Other studies suggest that these children may be at risk for high blood pressure and decreased self-esteem, both of which can seriously affect a child's overall quality of life. Obese children are also more likely to experience psychological and psychosocial consequences of their excess weight, including fewer years of education, lower family income, higher poverty rates, and lower marriage rates.

In addition obesity in childhood is a powerful predictor of obesity in adulthood, as shown by the Surgeon General's report in 2002 and Whittaker in 1997. It is estimated that overweight adolescents have a 70% chance of becoming overweight adults, increasing their long term risks of osteoarthritis, gall bladder disease, sleep apnea and respiratory problems, as well as breast, endometrial, prostate and colon cancers. Furthermore, the estimated cost associated with overweight/obesity was $99,200,000,000.00 in the year 1995

As childhood obesity continues to rise, these dire statistics are likely to worsen. Hence, early detection and treatment of obesity in children may be the best approach to prevent future increases in morbidity and mortality, as well as health costs, that will likely occur as overweight and obese children age. Child health experts recommend managing this epidemic by motivating families to increase physical activity, decrease sedentary behaviors, and improving eating patterns. These experts also emphasize the importance of specifying behavioral goals and involving parents in the treatment of childhood obesity.

### GENERAL DESCRIPTION OF THE INVENTION

In response to these recommendations, the inventors have developed the instant invention which is a computer application that enables parents to facilitate improvements in their children's dietary intake and activity levels by using access to computer games and other third party software and Internet sites as the primary motivator. The program acts as a gatekeeper, denying or limiting access to selected games locally or on-line until the child has achieved or made progress toward the behavioral goals agreed upon by parent and child. For example, using the application of the instant invention, a parent can input into the system a goal for their child to increase his or her physical activity, as measured by, e.g., a pedometer. With this goal established, the parent then inputs data each day into the child's personal computer or into another computer on a home network or on an on-line interface. Depending on the number of steps the child has taken that day, in the case of the pedometer, the child is allowed to play his or her favorite game for a pre-determined number of minutes. The goal could be a specific number of steps each day for a set number of minutes of game play, or the system can be set to enable access to the game on a steps per minute basis.

The program of the application is based on well-accepted principals of behavior modification, i.e., the program is designed to facilitate setting goals, monitoring progress and providing positive reinforcement. Each goal can be customized, and the positive reinforcement can be any program or game on the local personal computer or even an on-line chat group or game on the Internet. The program additionally advises and guides the parent through a series of wizards in setting measurable, realistic goals and in selecting appropriate time constraints for rewards.

The system is used by parents to provide incentives for children to eat fruits and vegetables, become more active, reduce the amount of TV time they watch or computer or computer games they play, or perform or not perform virtually any measurable behavior relating to physical activity, sedentary behavior or eating patterns. Additionally, more sophisticated devices can be used to add space automatically input data to reduce the burden of data entry. For example, a BodyMedia HealthWear Armband® can be used, rather than a simple pedometer, to allow access to the child's favorite games or other third party software for a predetermined amount of time, depending upon the number of steps input by the device.

Parents are the key to any intervention aimed at changing children's eating habits and exercise routines, as parents know their children's habits, good and bad. They usually have a fair understanding of what their children can and cannot do in terms of goals and which are more attainable. They are in an optimal position to select computer games or programs their children would find rewarding and that meet their own standards for language and sensitive themes. Most importantly, parents can discuss goals and rewards with their children, working with them to set up action plans. This is a critical element in the process, since having the children themselves involved in setting up the plans increases the likelihood of success.

In addition to their key role in setting up action plans, parents also act as powerful models for their children in terms of eating and activity patterns. Due to this influence, the instant invention includes a resource website for parents that includes tools, information, and support to help parents improve their own diet and exercise habits while helping their children do the same.

While the instant invention can be used with any age group and could even be used by the parents themselves to improve their own health, the group targeted by this inventive effort is the 9 to 11 years of age segment of youth. Children of this age are all in elementary school, still developing health habits and are equally balanced in terms of dependency on their parents and their quest for independence. In addition, this age range immediately precedes puberty, the age when those likely to become obese begin to gain excess weight.

Using pedometers to measure activity has been shown to be more accurate than self input or heart rate. The Body Media HealthWear Arnbands® are even more accurate than a simple pedometers and they can download data automatically. Focus is on intake of fruits and vegetables, as that choice being low-fat, high fiber has been shown to be an excellent replacement for high-fat food or junk food. TV watching is important as a focus point since researchers have found that there is a close response relationship between hours children spend watching TV and the incidence of obesity. The hours a child spends playing computer games or video games has also been shown to be a major factor in the increasing prevalence of childhood obesity.

A key advantage of the instant invention is its potential for promoting long-term behavior change. The interfaces are accessible both on the local computer that the child uses, on another computer on the home network and on-line. This allows parents to enter data locally or remotely, depending upon parental preference and/or Internet accessibility. Parents have flexibility in setting specific objectives in terms of steps, number of fruits and vegetables, hours of TV watching, and computer/video game playing. Parents also have control over the amount of time and selection of games, as well as other third party software, which may be used to reward children when the objectives are achieved. In addition, a resource website and an e-mail reminder and tip system is included.

While potential rewards are games that reside on the local PC, rewards can include Internet games, sites and chat rooms, as well. The e-mail reminder system for parents is included.

The program can be marketed to schools, wellness programs, physician groups, and through other distribution networks, such as Internet sites. The publicly documented application programming interface will allow third party vendors to create “plug-in” to enable customers to use other products in conjunction with the program. The program continues to grow in value and flexibility as more plug-ins become available. Since the parents have flexibility with the instant invention, it will allow for customization of goals and action plans. This allows for changes to be made as the child ages and improves.

Consequently, it is an object of this invention to provide a system by which a child's eating and health habits can be analyzed and directed to improved routines.

It is another object of this invention to provide a system by which parents can analyze their child's eating habits, their sedentary periods, their TV watching and their time spent playing computer/video games and make changes in those habits by behavior modification,

It is still another object of this invention to provide an application software for controlling a child's eating and physical activity behavior by rewarding certain actions and punishing others, and It is yet another object of this invention to provide a system for monitoring and controlling a child's dietary and activity habits by using parental inputs and measuring performance by means of a device worn by the child, and

Another object of the invention is to provide a system using third party interfaces and programmable and selectable applications to affect changes in a child's dietary and activity habits.

These and other objects will become apparent when reference is had to the accompanying specification and drawings in which

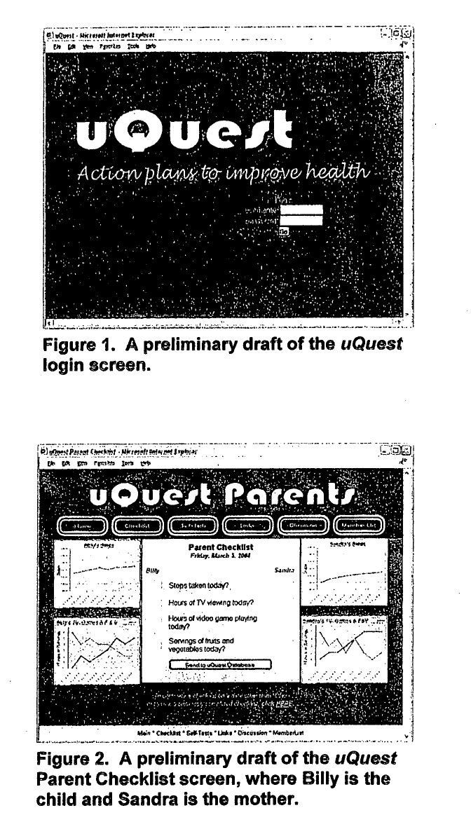

FIG. 1 shows the login screen.

FIG. 2 shows the Parent Checklist screen.

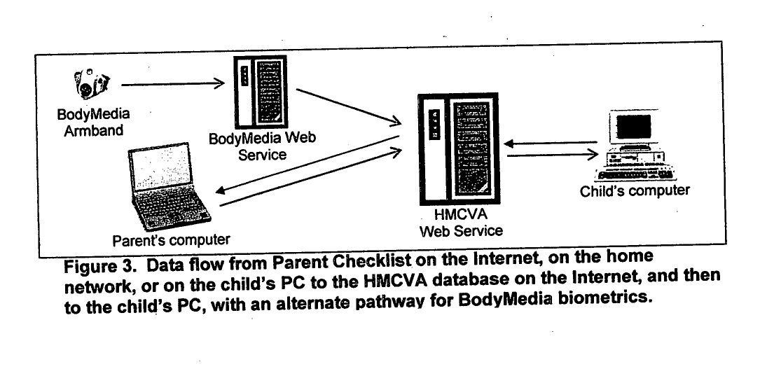

FIG. 3 is a diagrammatic data flow chart of the system.

### DETAILED DESCRIPTION OF THE INVENTION

The home computer initially contemplated for this invention is a PC with a CPU of 700 MHz, 128 of RAM, 700 MB of HD, a graphics accelerator card with 32 MB of VRAM, a CD-ROM drive and a minimum operating system of Windows 98SE.

The database is a SQL Server to track selections and data input by parents. The website and database are housed on an HMCVA Windows 2000 server that is firewall protected. The website is further protected with 128 bit encryption.

The core application uses VisualBasic.net and SQL server software to control access to third party software on the PC. The core application functions as a Windows service, loading at PC startup and running silently in the background.

Executable files of games or other third party software programs are monitored in a fashion similar to the task processing monitoring of Windows Task Manager. If the service detects that one of the selected programs or games is being started, it displays a system modal dialog requesting that the child enter a usemame and password. It then checks to see if the child with this usemame and password has met contingencies and/or goals set by his or her parent and, if so, allows the software to continue to run for a specified period of time.

As the child uses the game or program, the system continues to track minutes of usage. The system does not rely solely on the PC operating system for this timing function but will also monitor time using a clocking function within the program. When the allowed access time has been expended, another system modal dialog will inform the child that his or her allotted time is about to expire and advise him or her to save or quit the game or program. The warning dialog is then suppressed for a short time to allow for normal saving and shutdown to occur. If the game is not ended, then more frequent and insistent dialogs will appear, ultimately resulting in forced shutdown of the game with loss of unsaved data. If, on the initial attempt to load the game, the system determines that the child has not met parent's selected goals, or if the allowed time has already been expended, the game process will be programmatically forced to shut down and will display a dialog explaining why this action has occurred. In order to help parents set realistic goals, there will also be an “Assess” function available. Using this function children will be able to play without limits or contingencies for a specified period of time, as the application tracks the time in game play, reporting it back to parents for use as the average daily or weekly value.

Interfaces include those for logging in, setting up action plans, inputting data, and selecting preferences. The login interface is coded to enable parents to monitor more than one child using the same PC within the application. A parent can input different goals, contingencies, and selected third party software into the program, and the system tracks each of the children separately, allowing access to the games and programs accordingly. FIG. 1 shows the application log-in screen. FIG. 2 shows the parent checklist screen, with “Billy” as the child and “Sandra” as the mother.

Again, the “Assess” function provides parents with a baseline of their children's usual game play time. Step-by-step wizards are used to guide and educate parents in setting realistic, achievable goals and appropriate rewards for their children for the goals of (a) steps taken daily, (b) servings of fruits and vegetables, (c) hours of TV watching and (d) hours of computer/video game playing. These “wizards” encourage parents to assess current behaviors in these domains. They also provide recommendations regarding the percentage of increase and decrease from current behaviors when setting goals. Parents are encouraged to have weekly chats with their children to set new goals or to keep the same goals, depending on the success or failure during the previous week.

Parents may select games or third party software to be used as rewards by any one of three options. These are as follows:
Scan & Choose This is the easiest of the three methods and enables parents with little or no knowledge of computer file extensions to click on a button and set in motion a scanning process that will find well-know games that reside on the local hard drive of the child's PC. Parents also have the ability to select from the displayed list of games found during the scan for those they wish to use as rewards for desired behavior.
Discover This method requires no knowledge of computer file extensions and is used to identify less well-known games or programs that are not within the library of the core application. In this discovery mode, parents are asked to launch into whatever games or programs they wish to select for rewards. While the parent is so occupied, the system will “watch” to see what file is launched to identify the executable file for the particular game or program.
Browse This is for more computer savvy parents and allows them to manually browse for .exe files to select games and programs they wish to use as rewards for their child's good behavior.

Parents can choose which e-mail addresses they wish for reminders to be sent, whether they would like their child's computer clock locked to prevent tampering, or if they would like the application software to scan their child's system to identify newly installed games. The login interface is coded to identify unique associations between users and usemames/passwords and parent-child pairs. These unique associations are related to specific control domains which include goals, contingencies, selections of games/programs to be used as rewards, time expenditures on selected games/programs and user preferences. Examples of the technology to accomplish all of this is Kali.net's “scan for games”, the All-Seeing Eye and Game Spy. An XML database of known PC games for the library is employed and new game data automatically added during communications with a HMCVA site in a fashion similar to updating anti-virus files. For the “Scan & Choose” option, the system examines the local PC on startup to identify games that reside on the hard drive. Any additional executable files are registered using the “Browse” or “Discover” modes which allow parents to select from a menu a single game or a group of games to place within a control domain.

Using the wizards described previously, parents are able to configure each control domain (one control domain for each child) with a set of access requirements. The access requirements are structured to allow access to games in proportion to the behavioral goals set by parents, or as a fixed time for reaching specific thresholds of behavioral goals. Each control domain operates independently of other control domains but all control domains utilize accounting based on the same exercise and dietary performance parameters. Thus, in a manner analogous to a bank account, the child may expend his or her accrued behavior credit in any proportion on the games within the sphere of control associated with the control domain specified by his or her parent. The same games or programs are placed in any number of control domains, provided the domain containing the same game is associated with a different child. The parent application allows display of available games, as well as those that are currently monitored within control domains for each child. Reports are generated on each child's goal performance.

Data input from the parent checklist is programmed using the VisualBasic.net and SQL server. As shown in FIG. 3, data derived from the BodyMedia HealthWear Armband®, the digital device that tracks steps and automatically uploads when connected to the PC via USB. Coding activity data flows from the user's PC to the BodyMedia HealthWear Armband®, to the HMCVA Internet database, and back to the user's PC. This flow is shown in FIG. 3.

Using SQL mail, the e-mail reminders are coded to be sent automatically each day to the e-mail addresses identified as preferred by parents. The tips relating to children's health are drawn from the database in sequence, one each day, and embedded in the body of the message using Visual Basic.net. Parents' preferences are programmed to be stored in the SQL database and associated with the unique parent and child pairs in the same database. These preferences are implemented using Visual Basic.net.

Having described the preferred embodiment of the invention, it will be obvious to those of ordinary skill in the art that many changes and modifications can be made without departing from the scope of the appended claims.

1. A method of preventing and treating childhood obesity which involves parental or guardian involvement by means of interfacing with the personal computer of a child, the involvement attempting, by behavioral modification, to improve the child's diet and exercise regimen so as to treat any tendency toward obesity, said method comprising
a. providing a core application that controls access to third party software including at least one personal computer and at least one internet game,
b. Interfacing with said third party software which can be used by child to assist him or her in obtaining desired weight control results,
c. providing software interfaces to allow parents or guardians to set goals and contingencies and for data input,
d. coding said software interfaces to control the core application,
e. providing a resource website for parents or guardians,
f. providing interfaces to allow parents and guardians to make necessary changes to the goals and contingencies to better effect the child's ongoing behavior as to diet and exercise.

2. The method as in claim 1 wherein the parental interface is used to allow the child to access the third party software.

3. The method as in claim 2 wherein one of the third party software programs available for use is an Internet-enabled computer game designed to promote health and nutrition and physical activity.

4. The method as in claim 1 wherein one of the contingencies is for dealing with the condition that the child is not eating healthy foodstuffs.

5. The method as in claim 4 wherein the parents or guardians are able to reward the child for a proper diet by providing him or her access to play computer games, Internet sites or Internet-enabled applications including other third party software.

6. The method as in claim 1 wherein the child's efforts may be measured by third party hardware such as an automated physical activity monitor or pedometer.

7. The method as in claim 6 wherein the child is rewarded for achieving the exercise goal as measured by the automated physical activity monitor or pedometer.

8. The method as in claim 7 wherein the child's personal computer automatically denies him or her access to third party software if his or her performance does not meet pre-established goals.

9. The method as in claim 1 wherein parents or guardians may change goals and contingencies as the child ages and/or makes progress during his or her participation in the effort.

10. The method as in claim 9 wherein the parents may grant more or less access to third party software depending on the child's participation and progress.

11. The method as in claim 1 wherein the parent or guardian may input a certain number of steps taken from a pedometer into the core application on the child's personal computer or have networks or other computer connected to the Internet so as to constantly update the number of steps the child has achieved in each preset time period in order to avail himself or herself of the rewards.

12. The method as in claim 1 wherein the parents or guardian selects from a pre-selected and already provided list of rewards the child is to be granted access to if he or she performs so as to meet the goals set.

13. The method as in claim 1 wherein the core application has a separate and secure timing function so that the child cannot manipulate the reward time allowance.

14. The method as in claim 12 wherein the child's personal computer will show a dialog explaining why the child cannot access any particular reward function if he or she has not performed satisfactorily during the time period.

15. A method as in claim 1 wherein the interface will allow the parent or guardian to monitor more than one child at a time.

16. A method as in claim 1 wherein the interface provides a wizard program to allow the parents or guardians to set reasonable goals for each child using the system.

17. A method as in claim 16 wherein the wizard program correlates activity and desired parental goals in setting the number of steps taken daily, the servings of healthy foods, the hours of TV watching, and the hours of computer/video game playing.

18. A method as in claim 17 wherein the servings of healthy foods are taken to mean servings of fruit and vegetables.

19. A system for directing children on their personal computers to adopt a healthy regimen to offset tendencies toward obesity by improved diet and exercise, said system comprising:
a. core application software for controlling access to third party software,
b. a child's personal computer and a parents computer, both connected to said core application.
c. interfaces to allow parents to set goals and contingencies and for data input, said interfaces being coded to interface with the core application,
d. a resource website for parents, and
e. means of evaluating the results of the child's behavior as to healthy eating habits and exercise over time.

20. The system of claim 19 wherein the application allows the parent to limit access to third party software if the child has not performed satisfactorily in terms of exercise and diet.

21. The system of claim 19 wherein the system includes an automated physical activity monitor whereby the parent may monitor the exercise activity of the child which is automatically inputted into the interface.

22. The system as in claim 19 wherein the child's personal computer automatically denies him or her access to third party software if the child does not perform satisfactorily.

23. The system as in claim 22 wherein the child's computer automatically shows a dialog explaining to the child why the third party software is not available to him or her due to unsatisfactory performance.

24. The system as in claim 22 wherein the system has the Internet enabled game that reinforce good exercise and eating regimens.

25. The system as in claim 19 wherein the child's computer is one of a minimum of 700 MHz, 128 MB Ram, 700 MB HD, graphics accelerator card, CD-ROM drive and Windows 98 operating system.

26. The system as in claim 19 wherein the system has a SQL server database to track selected third party software and data input by parents.

27. The system as in claim 19 wherein the password to access the core application is encrypted.

28. The system as in claim 19 which has a website housed on a Windows 2000 and is firewall protected.
